(19) United States
(12) Patent Application Publication
(10) Pub. No.: US 2013/0014906 A1
(43) Pub. Date: Jan. 17, 2013

(54) VANE ASSEMBLY OF VERTICAL WINDOW BLIND AND THE VANE CARRIER THEREOF

(71) Applicants: Yu-Che Wen, Guishan Township (TW); Chih-Yao Chang, Taichung (TW)

(72) Inventors: Yu-Che Wen, Guishan Township (TW); Chih-Yao Chang, Taichung (TW)

(73) Assignee: NIEN MADE ENTERPRISE CO., LTD., Taichung (TW)

(21) Appl. No.: 13/453,961

(22) Filed: Apr. 23, 2012

(30) Foreign Application Priority Data
Jul. 12, 2011 (CN) 201120244229.1

(51) Int. Cl. E06B 9/36; A47H 15/02

(52) U.S. Cl. 160/166.1; 16/87 R

(57) ABSTRACT

A vane assembly of a vertical window covering includes a vane carrier and a vane hung thereon. The vane carrier has front wall and a rear wall with top ends connected to form a clip slot therebetween, and a hook on the rear wall in the clip slot. The hook has a slot and a slot bottom. The vane has a bore to engage the hook of the vane carrier. The slot bottom of the hook has a curved surface complementary to at least a portion of an edge of the bore to avoid damage of the vane.

### BACKGROUND OF THE INVENTION

1. Field of the Invention

The present invention relates generally to a window covering, and more particularly to a vane assembly of a vertical window blind and a vane carrier of the vane assembly.

2. Description of the Related Art

FIGs. from FIG. 1 to FIG. 3 show a conventional vane assembly of a vertical window blind, including a vane carrier 2 and a vane 1 hung on the vane carrier 2. The vane 1 has an elliptical bore 1a and a concave side 1b. The vane carrier 2 is mounted on a head rail (not shown), it has a front wall 2a and a rear wall 2b, these two walls 2a, 2b are parallel and kept a distance therebetween. The vane carrier 2 further has a hook 2c on an inner side 2d of the rear wall 2b to engage the elliptical bore 1a of the vane 1.

There are some drawbacks in the conventional vane assembly, including:
1. The hook 2c has a flat slot bottom 2e to contact an edge of the elliptical bore la of the vane 1. The sharp corners of the slot bottom 2e may damage the vane 1 when the vane 1 swings, usually caused by wind.
2. The vane 1 will slide by wind or other external force because the slot bottom 2e is flat and horizontal.
3. As shown in FIG. 3, the inner side 2d of the rear wall 2b is flat also that only the sharp corners of the rear wall 2b contact the concave side 1b of the vane 1. It will damage the vane 1 as well while the vane 1 swings or slides.

### SUMMARY OF THE INVENTION

The primary objective of the present invention is to provide a vane carrier of a vertical window blind, which has less risk to damage the vane hung on it.

According to the objective of the present invention, a vane carrier of a vertical window covering includes a front wall and a rear wall with top ends connected to form a clip slot therebetween; and a hook provided on the rear wall and in the clip slot. The hook has a slot and a slot bottom, and the slot bottom has a curved surface.

In an embodiment, the slot bottom of the hook slopes down towards the rear wall.

In an embodiment, the slot bottom of the hook has a flat middle portion and two curved portions at opposite sides of the middle portion.

In an embodiment, at least one of the front wall and the rear wall is provided with two curved corners.

In an embodiment, the front wall is provided with a protrusion, and the protrusion is in the clip slot and under the hook.

In an embodiment, the present invention further provides a vane carrier of a vertical window covering to hang a vane, including a front wall and a rear wall with top ends connected to form a clip slot therebetween; and a hook provided on the rear wall and in the clip slot. The hook has a slot and a slot bottom. At least one of the front wall and the rear wall is provided with two curved corners.

In an embodiment, the slot bottom of the hook has a curved surface.

In an embodiment, the slot bottom of the hook has a flat middle portion and two curved portions at opposite sides of the middle portion.

In an embodiment, the slot bottom of the hook slopes down towards the rear wall.

In an embodiment, the present invention further provides a vane assembly of a vertical window covering, including a vane carrier having front wall and a rear wall with top ends connected to form a clip slot therebetween, and a hook provided on the rear wall and in the clip slot, wherein the hook has a slot and a slot bottom; and a vane having a bore to engage the hook of the vane carrier. The slot bottom has a curved surface complementary to at least a portion of an edge of the bore.

In an embodiment, the bore of the vane is elliptical, and the slot bottom of the hook has a flat middle portion and two curved portions at opposite sides of the middle portion to fit the top edge of the bore.

In an embodiment, the vane carrier is provided with a protrusion on the front wall and under the hook, and the distance between the protrusion and the slot bottom of the hook is greater than a height of the bore of the vane.

In an embodiment, the distance between the slot bottom of the hook and a free end of the rear wall is greater than or identical to the distance between the protrusion and the slot bottom of the hook.

In an embodiment, the rear wall has two curved corners to fit a concave side of the vane.

In an embodiment, the front wall has two curved corners.

In an embodiment, the bore of the vane is round, and the slot bottom of the hook perfectly matches and contacts at least one third of a circumference of the bore.

### BRIEF DESCRIPTION OF THE DRAWINGS

FIG. 1 and FIG. 2 are sectional views of the conventional vane assembly;

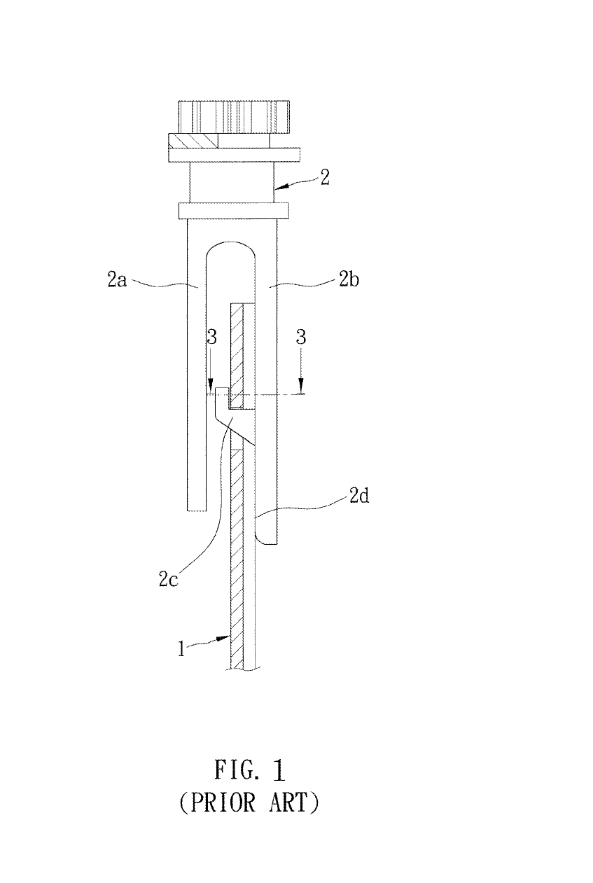

FIG. 3 is a sectional view along the 3-3 line in FIG. 1;

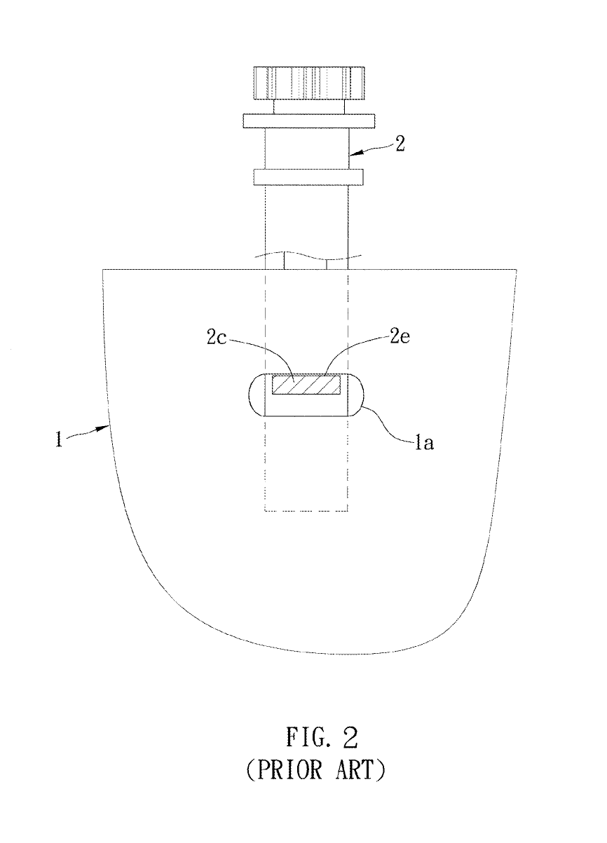

FIG. 4 is a perspective view of the vertical window blind of a first preferred embodiment of the present invention;

FIG. 5 is a sectional view of the vertical window blind of the first preferred embodiment of the present invention;

FIG. 6 is a lateral view of the vane carrier of the first preferred embodiment of the present invention;

FIG. 7 is a sectional view along the 7-7 line in the FIG. 6;

FIG. 8 is a sectional view along the 8-8 line in FIG. 5;

FIG. 9 is a sectional view of the vane assembly of the first preferred embodiment of the present invention; and

FIG. 10 is a sectional view of the vane assembly of a second preferred embodiment of the present invention.

### DETAILED DESCRIPTION OF THE INVENTION

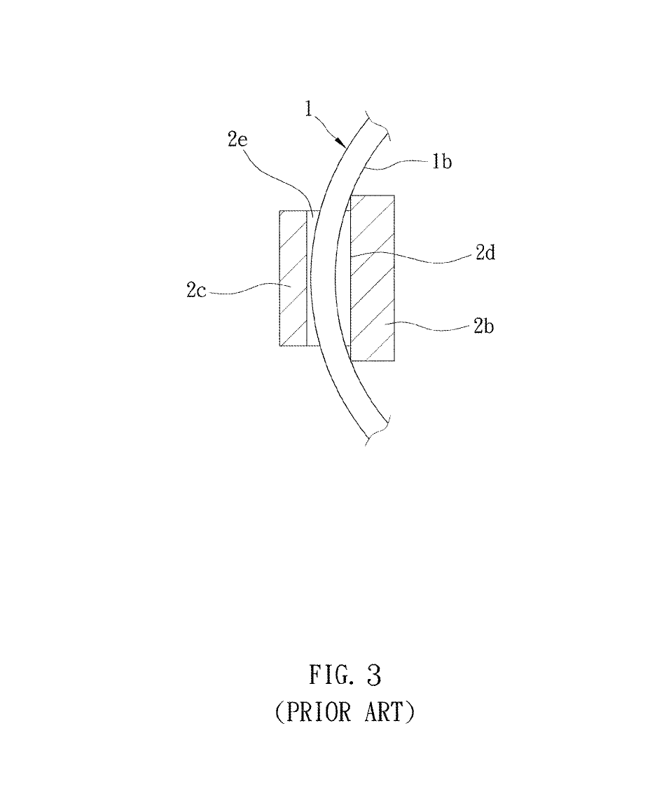

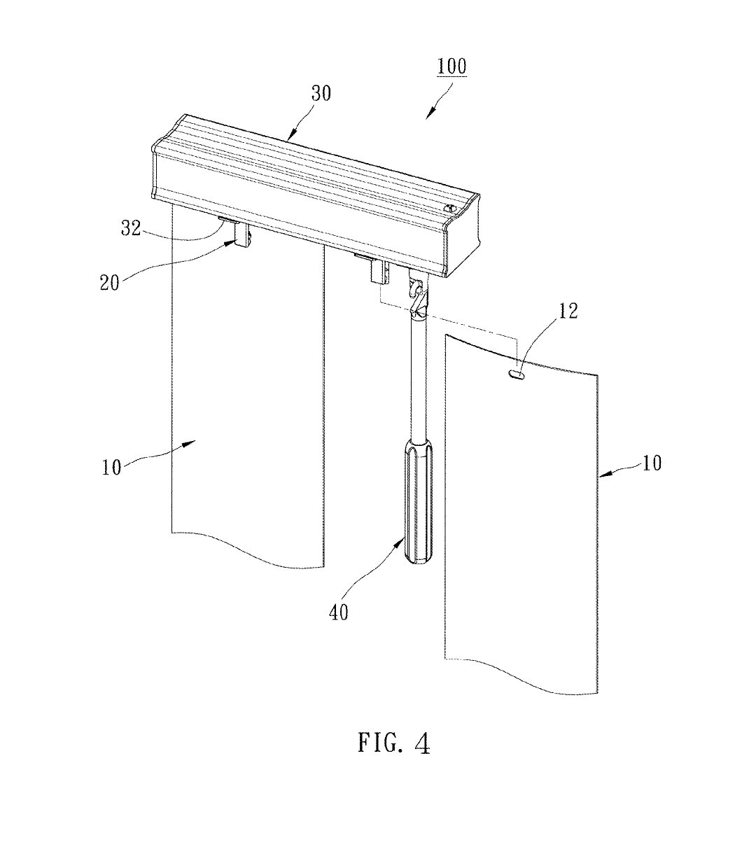

FIG. 4 and FIG. 5 show a vertical window blind of the first preferred embodiment of the present invention, including a head rail 30 and a plurality of vane assemblies 100. The head rail 30 is provided with a plurality of bases 32 on a bottom thereof, and the vane assemblies 100 respectively are connected to the bases 32. The bases 32 are slidable that the vane assemblies 100 may move along the head rail 30.

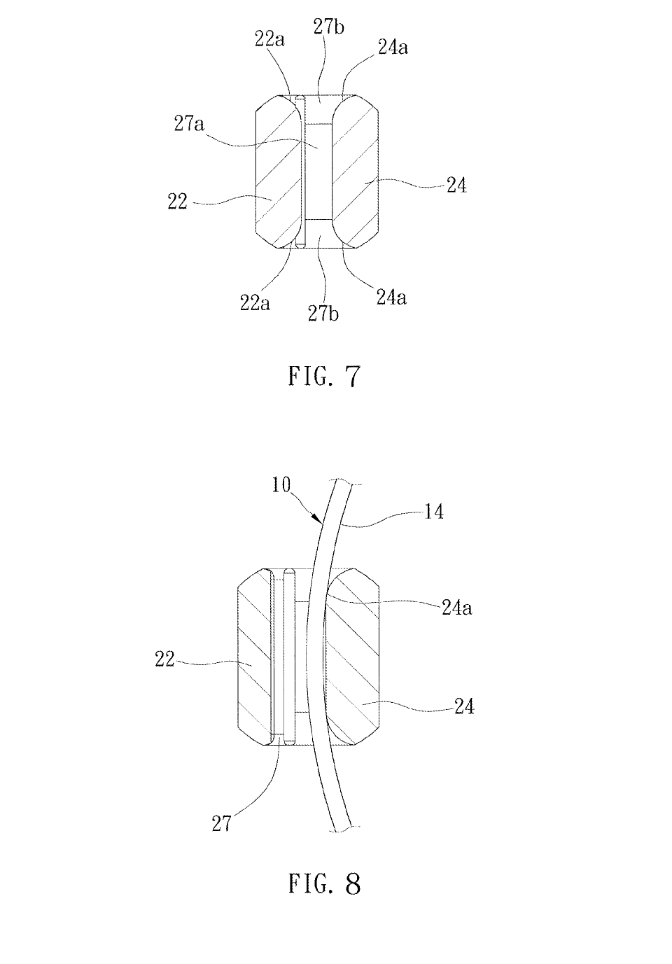

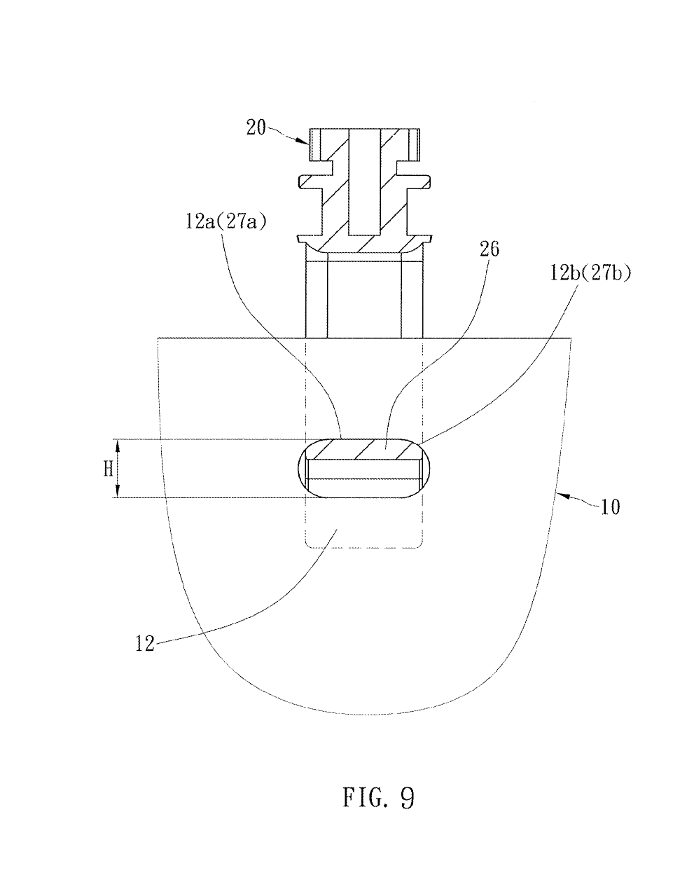

Each vane assembly 100 includes a vane 10 and a vane carrier 20. The vane 10 is vertical and has an elliptical bore 12 adjacent to top thereof. The bore 12 horizontally extends, and has two long and horizontal transverse edges 12a and two short and vertical lateral edges 12b, as shown in FIG. 9. A height H of the bore 12 is defined as a distance between the transverse edges 12a. The vane 10 has an arched cross-section, and has a concave side 14 as shown in FIG. 8.

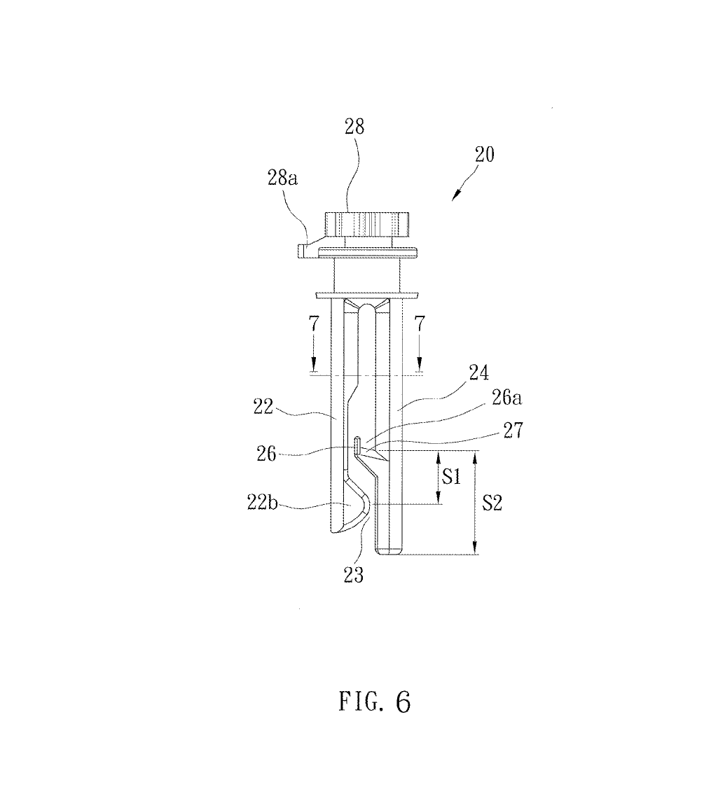

32 As shown in FIGS. 7, 8, and 9, the vane carrier 20 has a front wall 22, a rear wall 24, and a hook 26.

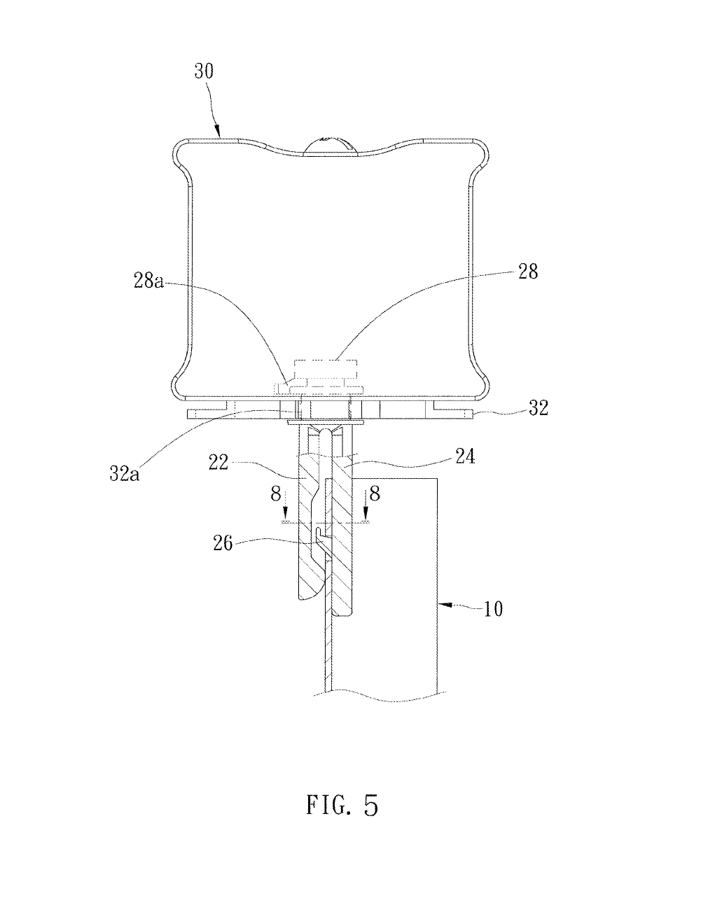

The front wall 22 and the rear wall 24 are parallel and separated from each other. Top ends of the walls 22, 24 are connected to a head 28 (as shown in FIG. 6) that a clip slot 23 is formed therebetween. The head 28 is provided with a locker 28a extending along a radial direction. The front wall 22 and the rear wall 24 respectively have two curved corners 22a and 24a, and curvatures of the curved corners 22a and 24a fit the concave side 14 of the vane 10. As shown in FIG. 8, the curved corners 24a make the rear wall 24 without the sharp point, and the vane 10 has almost entire area attached to the rear wall 24. In such condition, any movement or swing of the vane 10 will not easily cause damage of the vane 10. The front wall 22 has a protrusion 22b on an inner side thereof adjacent to a free end thereof. The protrusion 22b and the rear wall 24 may clip the vane 10.

As shown in FIG. 5, the vane carrier 20 is connected to the base 32 by inserting the head 28 and the locker 28a into an elongated opening 32a on a bottom of the base 32, and turning the vane carrier 20 to let the locker 28a leave the opening 32a. In other words, the head 28 of the vane carrier 20 is engaged with the head rail 30 through the base 32 and is rotatable so that the vane carrier 20 may be turned between a lock position, in which the locker 28a leaves the elongated opening 32a to couple the vane carrier 20 to the base 32, and an unlock position, in which the locker 28a is moved to the elongated opening 32a to disengage the vane carrier 20 with the base 32.

The hook 26 is formed on the inner side of the rear wall 24, and has a slot 26a and a slot bottom 27. The hook 26 engages the bore 12 of the vane 10 to hang the vane 10. The slot bottom 27 slopes down towards the rear wall 24 that the vane 10 hung thereon moves to the rear wall 24 by gravity and is normally attached to the rear wall 24 to avoid unexpected movement of the vane 10. The slot bottom 27 includes a flat middle portion 27a and two curved portions 27b at opposite sides of the middle portion 27a. It is preferable that the configuration of the slot bottom 27 fits the bore 12 of the vane 10. Consequently, the flat middle portion 27a fits the top transverse edge 12a, and the curved portions 27b fit the corners between the top transverse edge 12a and the lateral edge 12b, as shown in FIG. 9. Therefore, the slot bottom 27 has the entire area attached to the edge of the bore 12 of the vane 10 so that there is no stress concentration on the vane 10 to avoid damage of the vane 10.

As shown in FIG. 6, the protrusion 22b is under the hook 26, and the distance S1 between the slot bottom 27 of the hook 26 and the protrusion 22b is greater than the height H of the bore 12 of the vane 10, which is shown in FIG. 9. Furthermore, a distance S2 between the slot bottom 27 of the hook 26 and a free end of the rear wall 24 is greater than or at least identical to the distance S1. As a result, the vane carrier 20 will turn along with the vane 10, and the head 28 will disengage the base 32 when the locker 28 turns to the opening 32a (the unlock position). As a result, the vane carrier 20 and the vane 10 drop from the base 32 instead of breaking the vane 10 when the vane 10 is over-turned by wind or unexpected force.

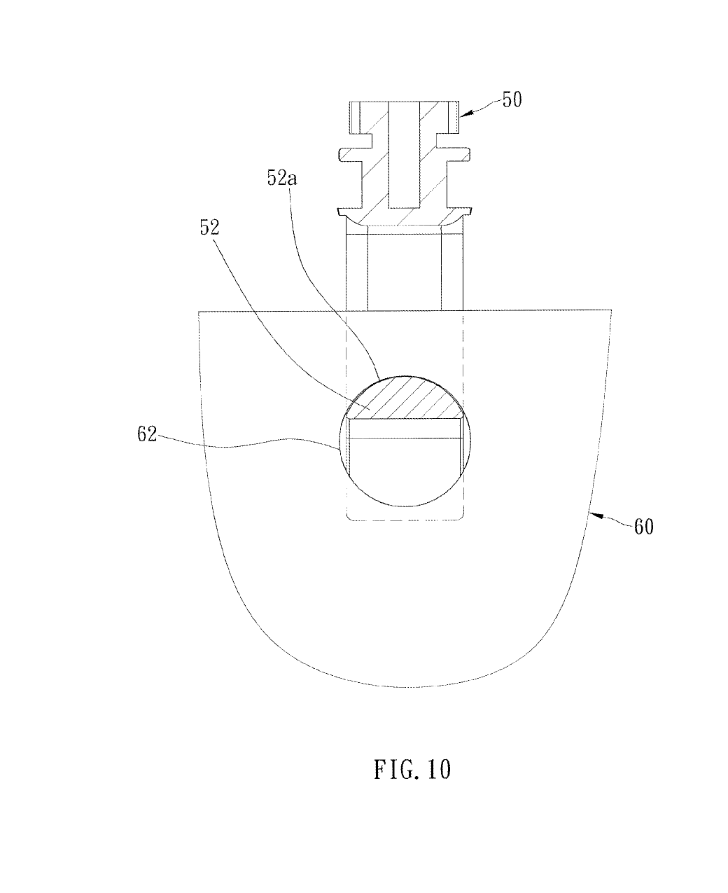

FIG. 10 shows a vane assembly of the second preferred embodiment of the present invention. The same as above, the vane assembly has a vane carrier 50 and a vane 60 hung on a hook 52 of the vane carrier 50. The different part is that the hook 52 has an arched slot bottom 52a to fit a round bore 62 of the vane 60. It is preferable that a length of the arched slot bottom 52a is greater than one third of a circumference of the bore 62 that the hook 52 may stably hold the vane 60.

The description above is only a few preferred embodiments of the present invention and the equivalence of the present invention is still in the scope of claim construction of the present invention.

What is claimed is:

1. A vane carrier of a vertical window covering, comprising:
a front wall and a rear wall with top ends connected to form a clip slot therebetween; and
a hook, which is provided on the rear wall and is in the clip slot, having a slot and a slot bottom, wherein the slot bottom has a curved surface;
wherein the curved surface of the hook is complementary to at least a portion of an edge of a bore of a vane hung on the hook.

2. The vane carrier as defined in claim 1, wherein the slot bottom of the hook slopes down towards the rear wall.

3. The vane carrier as defined in claim 1, wherein the slot bottom of the hook has a middle portion and two curved portions at opposite sides of the middle portion.

4. The vane carrier as defined in claim 1, wherein at least one of the front wall and the rear wall is provided with two curved corners.

5. The vane carrier as defined in claim 1, wherein the front wall is provided with a protrusion, and the protrusion is in the clip slot and under the hook.

6. The vane carrier as defined in claim 1, further comprising a head connected to the top ends of the front wall and the rear wall, wherein the head has a locker.

7. A vane carrier of a vertical window covering, comprising:
a front wall and a rear wall with top ends connected to form a clip slot therebetween; and
a hook, which is provided on the rear wall and is in the clip slot, having a slot and a slot bottom;
wherein at least one of the front wall and the rear wall is provided with two curved corners.

8. The vane carrier as defined in claim 7, wherein the slot bottom of the hook has a curved surface.

9. The vane carrier as defined in claim 8, wherein the slot bottom of the hook has a middle portion and two curved portions at opposite sides of the middle portion.

10. The vane carrier as defined in claim 7, wherein the slot bottom of the hook slopes down towards the rear wall.

11. The vane carrier as defined in claim 7, further comprising a head connected to the top ends of the front wall and the rear wall, wherein the head has a locker.

12. A vertical window covering, comprising:
a head rail having a plurality of openings;
a plurality of vane carriers, each of which has a front wall, a rear wall, and a head connected to top ends of the front wall and the rear wall, wherein a clip slot is formed between the front wall and the rear wall, a hook is provided on the rear wall and in the clip slot, and the head is provided with a locker; and
a plurality of vanes, each of which has a bore to engage the hook of the vane carrier;
wherein the head and the locker of the vane carrier is inserted into the opening of the head rail for rotation, and the vane carrier is turned between a lock position, in which the locker leaves the opening to couple the vane carrier to the head rail, and an unlock position, in which the locker is moved to the opening to disengage the head of the vane carrier with the opening of the head rail.

13. The vertical window covering as defined in claim 12, wherein the hook has a slot and a slot bottom, and the slot bottom has a curved surface complementary to at least a portion of an edge of the bore.

14. The vertical window covering as defined in claim 13, wherein the bore of the vane is elliptical, and the slot bottom of the hook has a middle portion and two curved portions at opposite sides of the middle portion to fit the edge of the bore.

15. The vertical window covering as defined in claim 12, wherein the vane carrier further has a protrusion on the front wall and under the hook, and a distance between the protrusion and the slot bottom of the hook is greater than a height of the bore of the vane.

16. The vertical window covering as defined in claim 14, wherein a distance between the slot bottom of the hook and a free end of the rear wall is greater than or identical to the distance between the protrusion and the slot bottom of the hook.

17. The vertical window covering as defined in claim 12, wherein the rear wall has two curved corners to fit a concave side of the vane.

18. The vertical window covering as defined in claim 16, wherein the front wall has two curved corners.

19. The vertical window covering as defined in claim 12, wherein the bore of the vane is round, and the slot bottom of the hook contacts at least one third of the edge of the bore.

20. The vertical window covering as defined in claim 12, wherein head rail is provided with a plurality of bases, the openings respectively are provided on the bases.
